(19) United States
(12) Patent Application Publication
(10) Pub. No.: US 2025/0195318 A1
(43) Pub. Date: Jun. 19, 2025

(54) ARC LIGHT AND VIBRATION MASSAGE DEVICE

(71) Applicant: Dongguan Dingfoo Plastic Products Co.,Ltd., Zhejiang (CN)

(72) Inventor: Qiuming LIU, Zhejiang (CN)

(73) Assignee: Dongguan Dingfoo Plastic Products Co.,Ltd., Zhejiang (CN)

(21) Appl. No.: 18/984,889

(22) Filed: Dec. 17, 2024

(30) Foreign Application Priority Data
Dec. 18, 2023 (CN) 202323443676.1

(51) Int. Cl. A61H 15/02; A61H 15/00; A61H 23/02

(52) U.S. Cl. CPC A61H 15/02; A61H 23/02; A61H 2015/0071; A61H 2201/10; A61H 2201/1685

(57) ABSTRACT

An arc light and vibration massage device comprises a housing, an arc light generation module, a power module and a first vibration motor, wherein the power module and the first vibration motor are arranged in the housing, a portion of the arc light generation module is arranged outside the housing, the arc light generation module and the first vibration motor are electrically connected to the power module, a vibration portion of the first vibration motor abuts against the arc light generation module, and the arc light generation module emits arc light.

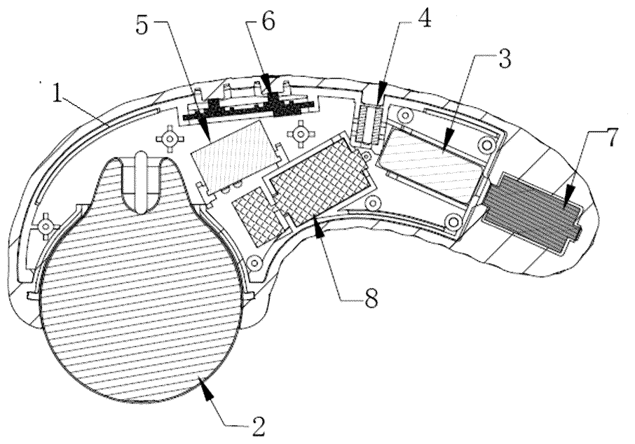

### CROSS-REFERENCE TO RELATED APPLICATION

This application claims the priority benefit of China application Ser. No. 202323443676.1, filed on Dec. 18, 2023. The entirety of the above-mentioned patent application is hereby incorporated by reference herein and made a part of this specification.

### BACKGROUND

### Technical Field

The disclosure relates to a massage device, in particular to an arc light and vibration massage device.

### Description of Related Art

The development of modern society leads to an increasingly rapider life pace, and people often massage their neck and head in leisure time or when necessary. Existing massage devices have only one function and cannot fulfill multiple functions, thus limiting the application range and effect of massage devices. Particularly, the existing massage devices do not have a phototherapy function or other health-care functions.

### SUMMARY

The technical issue to be settled by the disclosure is to provide an arc light and vibration massage device to solve the technical problem that existing massage devices have only one function.

The technical solution adopted by the disclosure is as follows: an arc light and vibration massage device comprises a housing, an arc light generation module, a power module and a vibration module, wherein the power module and the first vibration motor are arranged in the housing, a portion of the arc light generation module is arranged outside the housing, the arc light generation module and the first vibration motor are electrically connected to the power module, a vibration portion of the first vibration motor abuts against the arc light generation module, and the arc light generation module emits arc light.

Further, the portion, outside the housing, of the arc light generation module is arc-shaped.

Further, an inner layer of the housing is concaved and fits heads.

Further, the arc light and vibration massage device further comprises a second vibration motor, and the second vibration motor is arranged at an end, opposite to the arc light generation module, of the housing.

Further, the arc light generation module is an electrostatic ball.

Further, the arc light and vibration massage device further comprises a boost module, and the power module is connected to the arc light generation module by means of the boost module.

The disclosure has the following technical effects: the arc light and vibration massage device comprises a housing, an arc light generation module, a power module and a first vibration motor, the power module and the first vibration motor are arranged in the housing, a portion of the arc light generation module is arranged outside the housing, the arc light generation module and the first vibration motor are electrically connected to the power module, a vibration portion of the first vibration motor abuts against the arc light generation module, and the arc light generation module emits arc light. An arc light device is arranged on a vibration massage device, such that light and heat can be generated for health care when the device used by users for massage, and the functions of the arc light and vibration massage device are fully expanded.

### BRIEF DESCRIPTION OF THE DRAWINGS

Figure is a schematic structural view of the disclosure.

### DESCRIPTION OF THE EMBODIMENTS

The technical solution of the disclosure is further described below in conjunction with specific embodiments.

As shown in figure, in a specific embodiment of the disclosure, an arc light and vibration massage device comprises a housing 1, an arc light generation module 2, a power module 3 and a first vibration motor 8, wherein the power module 3 and the first vibration motor are arranged in the housing 1, a portion of the arc light generation module 2 is arranged outside the housing 1, the arc light generation module 2 and the first vibration motor 8 are electrically connected to the power module 3, a vibration portion of the first vibration motor 8 abuts against the arc light generation module 2, and the arc light generation module 2 emits arc light.

As shown in figure, the specific implementation of the disclosure is as follows: the arc light and vibration massage device further comprises a key and a PCBA control board 6, wherein the key is connected to the PCBA control board 6, the PCBA control board 6 is connected to the power module 3 and the first vibration motor 8, the power module 3 and the first vibration motor are arranged in the housing 1, a portion of the arc light generation module 2 is arranged outside the housing 1, and the arc light generation module 2 is electrically connected to the power module 3. When the key is turned on, the PCBA control board 6 controls the first vibration motor 8 to generate vibrations, the vibration portion of the first vibration motor 8 abuts against the arc light generation module 2, and the vibrations of the first vibration motor 8 drive the arc light generation module 2 to vibrate to realize vibration massage. Arc light emitted by the arc light generation module 2 is used for health care of human parts.

As shown in figure, in a preferred embodiment of the disclosure, the portion, outside the housing, of the arc light generation module 2 is arc-shaped, such that the arc light generation module 2 can perform vibration massage easily. An inner layer of the housing 1 is concaved to fit heads. The arc light and vibration massage device is generally used for massaging heads. Therefore, the inner layer of the housing 1 is designed to be concaved to fit the heads to be used conveniently.

As shown in figure, in a preferred embodiment of the disclosure, the arc light and vibration motor further comprises a second vibration motor 7, and the second vibration motor 7 is arranged at an end, opposite to the arc light generation module 2, of the housing 1, that is, the second vibration motor 7 and the arc light generation module 2 are located at two ends of the housing 1 respectively, such that the second vibration motor 7 can vibrate to massage other parts.

As shown in figure, in a preferred embodiment of the disclosure, the arc light generation module 2 is an electrostatic ball. The arc light generation module generates arc light by means of current passing through two electrodes. Compared with traditional incandescent lamps, an arc lamp has higher brightness and a longer service life. The arc light generation module 2 is formed by a filament, gas filler, a glass shell and an electronic element. The arc light and vibration massage device further comprises a boost module 5, wherein the boost module 5 is connected to the arc light generation module 2, and the power module 3 is connected to the arc light generation module 2 by means of the boost module 5. The boost module 5 generates a high voltage to drive the arc light generation module 2 to operate to generate arc light.

The disclosure has the following technical effects: the arc light and vibration massage device comprises a housing 1, an arc light generation module 2, a power module 3 and a first vibration motor 8, the power module 3 and the first vibration motor are arranged in the housing 1, a portion of the arc light generation module 2 is arranged outside the housing 1, the arc light generation module 2 and the first vibration motor 8 are electrically connected to the power module 3, a vibration portion of the first vibration motor 8 abuts against the arc light generation module 2, and the arc light generation module 2 generates arc light for phototherapy. An arc light device is arranged on a vibration massage device, such that light and heat can be generated for health care when the device used by users for massage, and the functions of the arc light and vibration massage device are fully expanded.

The disclosure is described above in further detail in conjunction with specific preferred embodiments, but the specific implementation of the disclosure is not limited to the above description. For those ordinarily skilled in the art, some simple deductions or substitutions can be made without departing from the concept of the disclosure, and all these deductions or substitutions should also fall within the protection scope of the disclosure.

What is claimed is:

1. An arc light and vibration massage device, comprising:
a housing, an arc light generation module, a power module and a vibration module, wherein the power module and a first vibration motor are arranged in the housing, a portion of the arc light generation module is arranged outside the housing, the arc light generation module and the first vibration motor are electrically connected to the power module, a vibration portion of the first vibration motor abuts against the arc light generation module, and the arc light generation module generates arc light.

2. The arc light and vibration massage device according to claim 1, wherein the portion, outside the housing, of the arc light generation module is arc-shaped.

3. The arc light and vibration massage device according to claim 1, wherein an inner layer of the housing is concaved and fits heads.

4. The arc light and vibration massage device according to claim 1, further comprising a second vibration motor, wherein the second vibration motor is arranged at an end, opposite to the arc light generation module, of the housing.

5. The arc light and vibration massage device according to claim 1, wherein the arc light generation module is formed by a filament, gas filler, a glass shell and an electronic element.

6. The arc light and vibration massage device according to claim 1, wherein the arc light generation module is an electrostatic ball.

7. The arc light and vibration massage device according to claim 1, further comprising a boost module, wherein the power module is connected to the arc light generation module by means of the boost module.
